(19) United States
(12) Patent Application Publication
(10) Pub. No.: US 2018/0295823 A1
(43) Pub. Date: Oct. 18, 2018

(54) ARTIFICIAL BAIT FOR FISHING, USING ATTRACTANT

(71) Applicant: Jae Hyuk YANG, Daegu (KR)

(72) Inventor: Jae Hyuk YANG, Daegu (KR)

(21) Appl. No.: 16/013,648

(22) Filed: Jun. 20, 2018

Related U.S. Application Data
(63) Continuation of application No. PCT/KR2016/014996, filed on Dec. 21, 2016.

(30) Foreign Application Priority Data
Dec. 21, 2015 (KR) 10-2015-0182574

(51) Int. Cl. A01K 85/01

(52) U.S. Cl. CPC A01K 85/01

(57) ABSTRACT

The present invention relates to artificial bait for fishing, using an attractant and, more specifically, to artificial bait for fishing, using an attractant and comprising: an artificial bait body having an accommodation space therein, and having an inlet hole through which water flows into the accommodation space by water pressure during fishing; and an attracting agent made of an attractant and insertably and separably provided in the accommodation space, such that the water flowing through the inlet hole comes in contact with the attracting agent so as to discharge the attractant to the outside through a discharge hole of the artificial bait body.

### CROSS-REFERENCE TO RELATED APPLICATIONS

The present application is a continuation of International Patent Application No. PCT/KR2016/014996, filed on Dec. 21, 2016, which is based upon and claims the benefit of priority to Korean Patent Application No. 10-2015-0182574, filed on Dec. 21, 2015. The disclosures of the above-listed applications are hereby incorporated by reference herein in their entirety.

### BACKGROUND OF THE INVENTION

### Field of the Invention

The present invention relates to an artificial bait for fishing, using an attractant, and more specifically to an artificial bait for fishing, to which an attractant agent is coupled in various forms and methods so as to lure fishes in an olfactory and visual manner.

### Related Art

Fishing is the activity of trying to catch fishes, shellfishes, crustaceans, and any other marine animals using tools including a fly rod, a fishing line, and a hook. Although there is no consensus statistics on the number of people enjoying fishing as a hobby and a quantity of fishes caught by them, it is argued that few millions of tons of fishes are caught per year.

As such, the number of people enjoying fishing as a hobby and the size of the fishing industry have been not yet estimated accurately. However, as a fishing-related program airs on a cable channel and sea-fishing is introduced in various entertaining show programs, it is considered that more and more people start to enjoy fishing for pleasure.

Meanwhile, various types of baits are used for fishing, and artificial baits rather than live baits like clam worms and squid may be used depending on a fishing method.

However, an attractant of those artificial baits is not replaceable according to an environment, and it is not possible to properly adjust the dispersing rate of the attractant and the amount thereof, and thus, such artificial baits can be used only in limited conditions.

Therefore, it is necessary to consider an artificial bait of which an attractant can be replaceable depending on a fishing method or a type of a fish or adjustable in dispersing rate or quantity.

### SUMMARY

The present invention is proposed to solve the above-described drawbacks, and a technical task thereof is to provide an artificial bait for fishing, using an attractant, the artificial bait in which an attracting agent of various types is insertably and separably coupled to an artificial bait body in various methods according to a fishing method or a type of a fish to be caught, and which is able to lure fishes in an olfactory and visual manner and adjust an amount of the attractant to be discharged by adjusting water pressure on an artificial bait, for example, shaking a fishing rod.

Technical tasks obtainable from the present invention are non-limited the above-mentioned technical task. And, other unmentioned technical tasks can be clearly understood from the following description by those having ordinary skill in the technical field to which the present invention pertains

To object of the present invention may be obtained by an artificial bait for fishing, using an attractant, including: an artificial bait body having an accommodation space therein, and an inlet hole through which water flows into the accommodation space by water pressure during fishing; and an attracting agent made of the attractant and insertably and separably provided in the accommodation space, wherein the water flowing through the inlet hole comes into contact with the attracting agent to discharge the attractant to an outside through a discharge hole of the artificial bait body during fishing.

In addition, the attracting agent may be in at least one type from among a liquid type, a foaming type, and a capsule type.

In addition, at least one of the inlet hole or the discharge hole may be formed as at least one or more formed in a longitudinal direction or a lateral direction of the artificial bait body in the accommodation space.

In addition, the attracting agent may be refillable, the attracting agent of the liquid type may be refillable by a liquid injecting device having an injection needle, and the attracting agent of the foaming type or the capsule type may be refillable by mounting the foaming type or the capsule type to an insertion rod and inserting the insertion rod into the inlet hole or the discharge hole.

In addition, the attractant may be in red and composed of at least one of fish food, fish powder, fish oil, fish blood, grain powder, or organic binder, and the attracting agent of the forming type further may include hydrogen carbonate and carbonate powder.

According to an embodiment of the present invention, an attracting agent of various types may be insertably and separably coupled to an artificial bait body in various methods according to a fishing method or a type of a fish to be caught, and it is possible to lure fishes in an olfactory and visual manner and adjust the amount of the attractant to be discharged by adjusting water pressure on an artificial bait, for example, shaking a fishing rod.

Meanwhile, effects obtainable from the present invention are not limited by the above mentioned effect. Other unmentioned effects can be clearly understood from the following description by those having ordinary skill in the technical field to which the present invention pertains.

### BRIEF DESCRIPTION OF THE DRAWINGS

FIG. 1 is a picture of an artificial bait for fishing, using an attractant, according to an embodiment of the present invention.

FIG. 2 is an artificial bait for fishing, using an attractant, the bait which has various types of an exterior appearance of soft plastic according to an embodiment of the present invention.

FIG. 3 is an artificial bait for fishing, using an attractant, the bait which has various types of an exterior appearance of plastic according to an embodiment of the present invention.

FIGS. 4 and 5 are perspective views of an artificial bait for fishing, using an attractant, according to an embodiment of the present invention.

FIG. 6 is an exploded perspective view of an artificial bait for fishing, using an attractant, according to an embodiment of the present invention.

FIG. 7 is a partial perspective view of an artificial bait for fishing, using an attractant, according to an embodiment of the present invention.

FIGS. 8 and 9 are a diagram showing a use state of an existing artificial bait and a diagram showing a use state of an artificial bait for fishing, using an attractant, according to an embodiment of the present invention.

FIG. 10 is a cross-sectional view of an artificial bait for fishing, having a liquid-type attracting agent filled therein, according to an embodiment of the present invention.

FIG. 11 is a cross-sectional view of an artificial bait for fishing, having a capsule-type attracting agent provided therein, according to an embodiment of the present invention.

FIG. 12 is a cross-sectional view of an artificial bait for fishing, having a foaming-type attracting agent provided therein, according to an embodiment of the present invention.

FIG. 13 is a perspective view of a foaming-type attracting agent according to an embodiment of the present invention.

FIG. 14 is a cross-sectional view of an artificial bait for fishing in a state in which attractant is being discharged by inflow of water according to an embodiment of the present invention.

FIG. 15 is a cross-sectional view of an artificial bait for fishing, the bait in which an inlet hole and a discharge hole are formed in a lateral direction according to an embodiment of the present invention.

FIG. 16 is a cross-sectional view of an artificial bait for fishing, the bait in which an inlet hole and two inclined discharge holes are formed in a longitudinal direction according to an embodiment of the present invention.

FIG. 17 is a cross-sectional view of an artificial bait for fishing, the bait which has a plurality of attracting agents in an accommodation space and a plurality of inlet holes and discharge holes formed in lateral directions according to an embodiment of the present invention.

FIG. 18 is a perspective view of an artificial bait for fishing, the bait which has a plurality of attracting agents in an accommodation space and a plurality of inlet holes and discharge holes formed in lateral directions according to an embodiment of the present invention.

FIG. 19 is a cross-sectional view of a state in which a liquid-type attracting agent is being filled in an accommodation space of an artificial bait body through a liquid injecting device according to an embodiment of the present invention.

FIG. 20 is a cross-sectional view of a state in which a foaming-type or a capsule-type attracting agent is being filled through an insertion rod according to an embodiment of the present invention.

FIG. 21 is an exploded perspective view of an apparatus of manufacturing an artificial bait for fishing according to an embodiment of the present invention.

FIG. 22 is a front view of an insertion pin installed in a third mold according to an embodiment of the present invention.

FIG. 23 is a perspective view of an apparatus of manufacturing an artificial bait for fishing according to an embodiment of the present invention.

### DETAILED DESCRIPTION

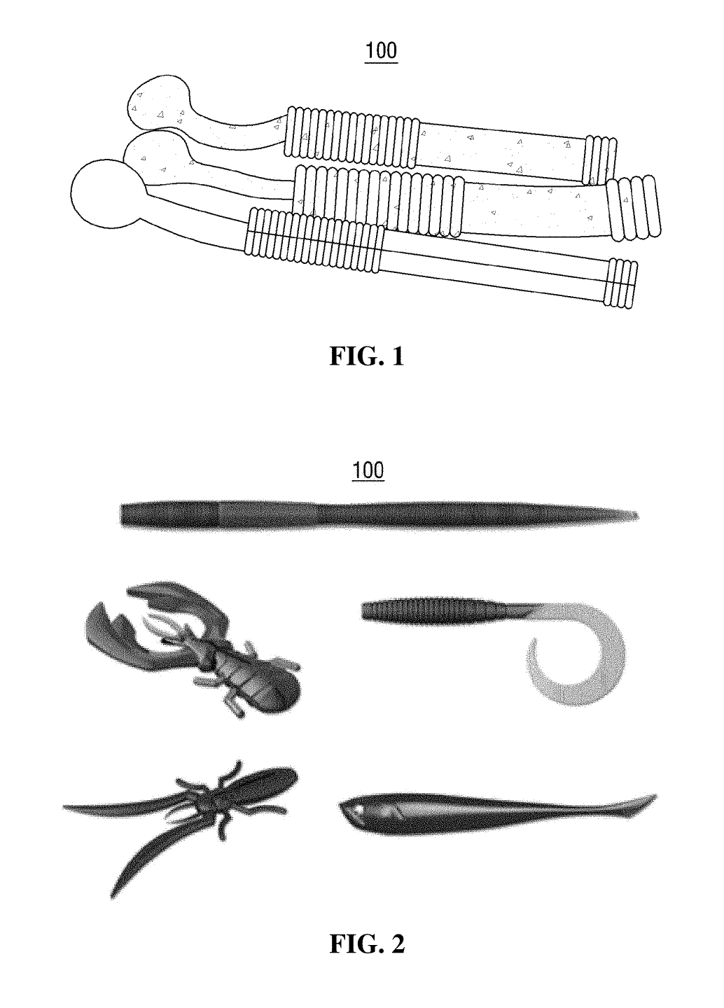

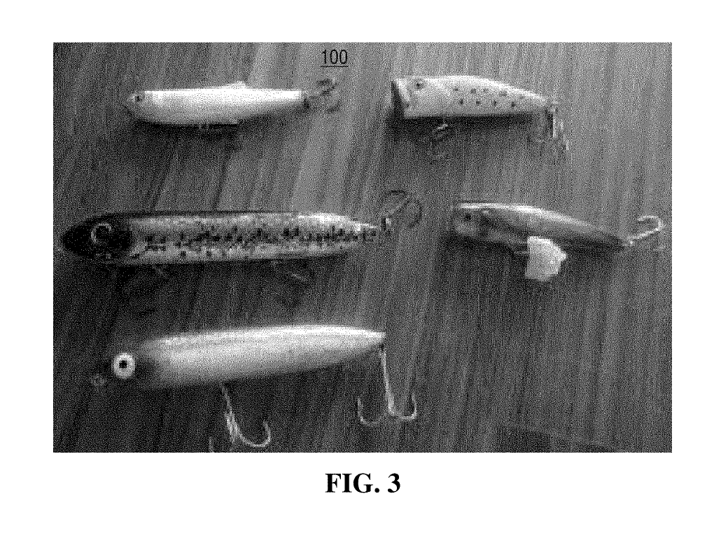

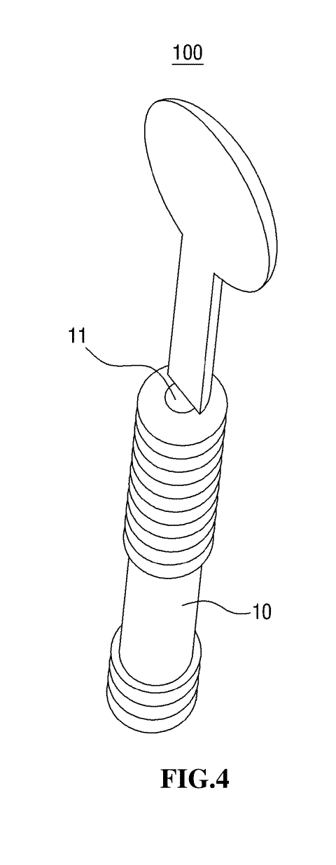

In the following description, configuration and functions of an artificial bait 100 for fishing, using an attractant, according to an embodiment of the present invention will be described. First, FIG. 1 shows a picture of the artificial bait 100 according an embodiment of the present invention. FIG. 2 shows the artificial bait 100 having various types of an exterior appearance of soft plastic according to an embodiment of the present invention, and FIG. 3 shows the artificial bait 100 having various types of an exterior appearance of plastic according to an embodiment of the present invention.

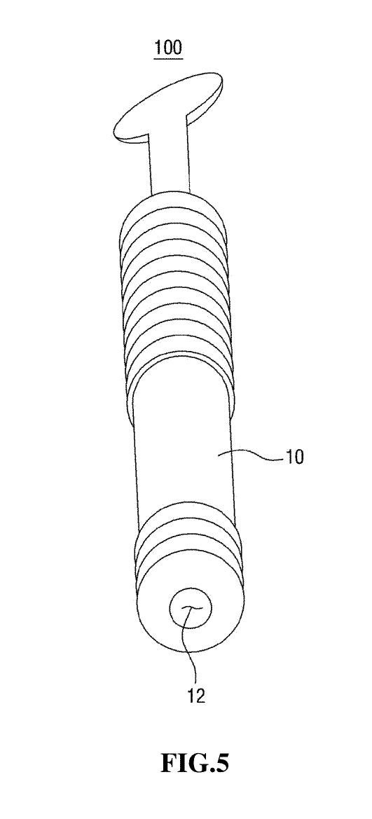

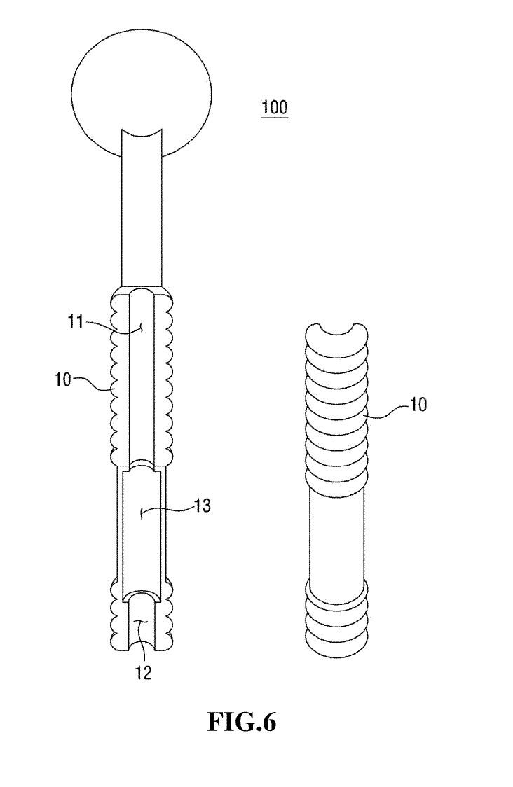

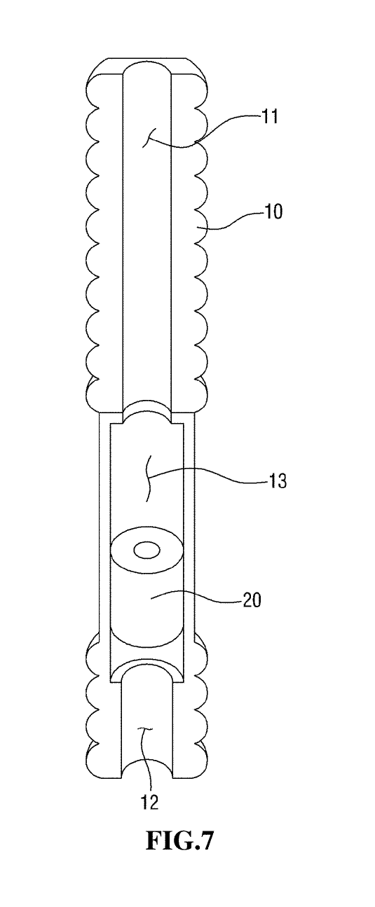

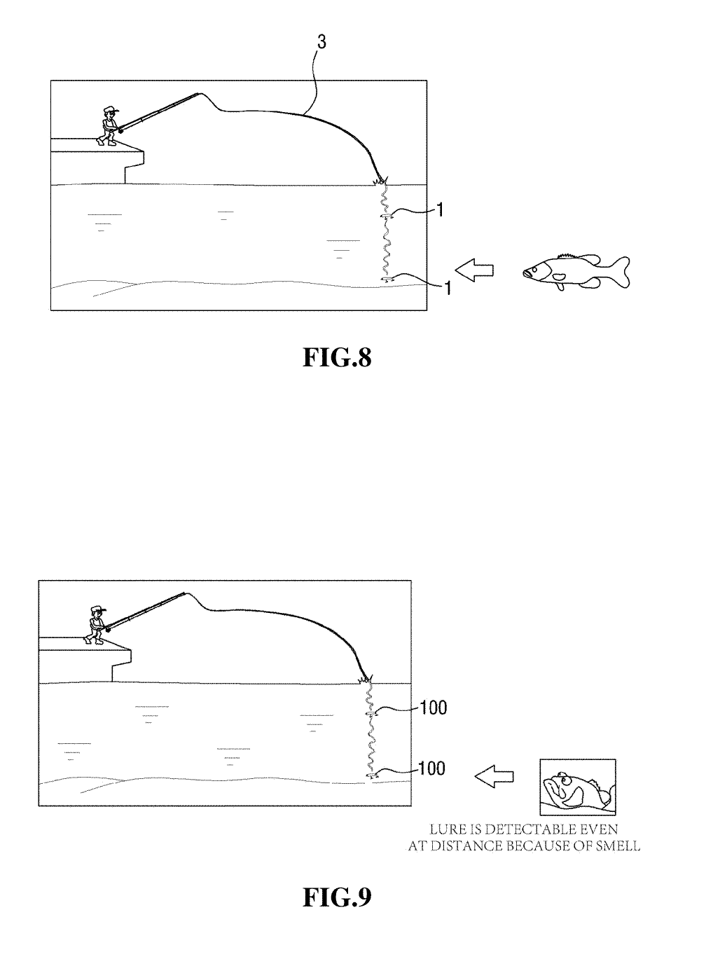

In addition, FIGS. 4 and 5 are perspective views of the artificial bait 100 according to an embodiment of the present invention. FIG. 6 is an exploded perspective view of the artificial bait 100 according to an embodiment of the present invention. FIG. 7 is a partial perspective view of the artificial bait 100 according to an embodiment. FIGS. 8 and 9 is a diagram illustrating a use state of an existing artificial bait 1 and a diagram illustrating a use state of the artificial bait 100 according to an embodiment of the present invention.

The artificial bait 100 according to an embodiment of the present invention is configured to have an attracting agent 20 made of an attractant in an artificial bait body 10.

The artificial bait body 10 has an accommodation space 13 formed therein, and includes an inlet hole 11 through which water flows into the accommodation space 13 by water pressure during fishing. In addition, the attracting agent 20 is made of an attractant and insertably and separably provided in the accommodation space 13.

As illustrated in FIGS. 1 to 3, the artificial bait 10 may be in any of various shapes, such as a fish shape, an annelida shape like a worm, a larva shape, and a small animal shape, and the artificial bait body 10 may vary in shape, size, color, and material according to a purpose and an environment for use. Furthermore, the artificial bait body 10 may be a soft bait of soft plastic, as illustrated in FIG. 2, or may be a hard bait of plastic.

In addition, as illustrated in FIGS. 4 to 7, the accommodation space 13 is formed in the artificial bait body 10, and the attracting agent 20 of various types is insertably and separably embedded in the accommodation space 13. In addition, there are formed the inlet hole 11 penetrating between one side of an outer surface of the artificial bait body 10 and the accommodation space 13, and a discharge hole 12 penetrating the other side of the outer surface of the artificial bait body 10 and the accommodation space 13.

Thus, as illustrated in FIG. 9, when water flowing through the inlet hole 11 comes into contact with the attracting agent 20, the attractant is slowly discharged through the discharge hole 12 to an outside, thereby attracting fishes. In addition, such an attractant is configured to be in red, and thus, when dispersed in water, the attractant mimics the effect of animal blood, thereby luring fishes in an olfactory and visual manner.

Such an attractant is configured to be in read and composed of at least one from among fish food, fish powder, fish oil, fish blood, grain powder, and organic binder.

That is, the present invention takes advantages of fishes' characteristics that fishes attack any other wound fish to death when the wound fish loses scale or appears sick and that fishes immediately find out and eat up an wound insect like an orthoptera or a mentis using a very sensitive olfactory sense, so the present invention mimics a sick fish or an wound insect so as to lure fishes in an olfactory and visual manner.

In addition, the artificial bait body 10 according to an embodiment of the present invention may have two or more separate units assembled into one body, or may have both sides hinge-coupled to each other to open and close the artificial bait 10 so that the attracting agent 20 in the accommodation space 13 may be re-filled by opening the artificial bait body 10.

In addition, the attracting agent 20 according to an embodiment of the present invention may be in any of various type, including a liquid type 21, a foaming type 23, or a capsule type 22.

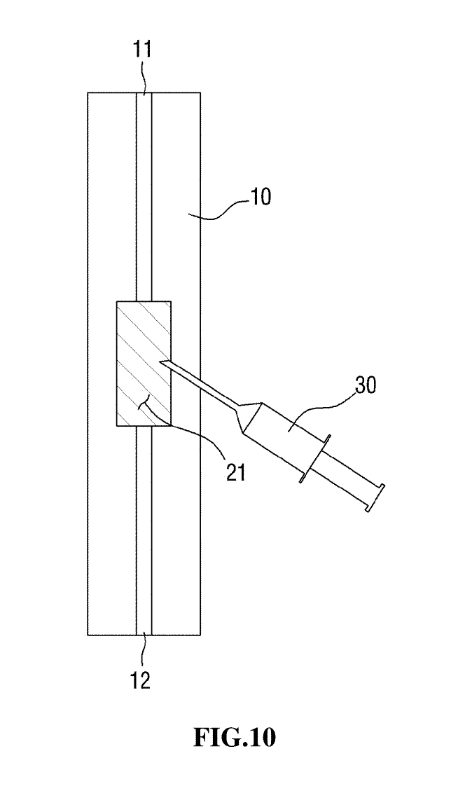

FIG. 10 shows a cross sectional view of the artificial bait 100 with the liquid-type attracting agent 21 refilled therein according to an embodiment of the present invention. As illustrated in FIG. 10, a liquid-type attracting agent 21 whose attractant of the liquid type 21 are capable of being injected into the accommodation space 13 using a syringe may be applicable.

When the attracting agent 20 of the above type is used, a user may adjust the amount of the attractant to be discharged, by adjusting the amount of the attractant to be injected. When the attractant runs out after a predetermined period of time, the user may inject an attractant again into the accommodation space 13 using a syringe-type liquid injecting device 30 so as to re-use the attracting agent 20.

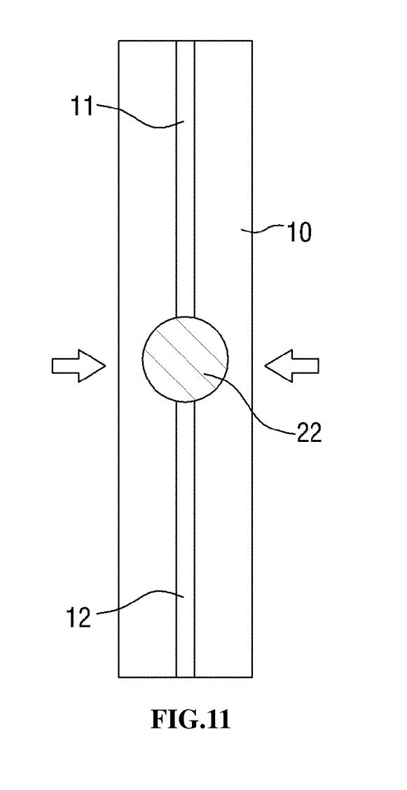

FIG. 11 shows a cross-sectional view of the artificial bait 100 having a capsule-type attracting agent 22 therein according to an embodiment of the present invention. As illustrated in FIG. 11, the capsule-type attracting agent 22 corresponds to a type in which the capsule 22 filled with an attractant is inserted in the accommodation space 13. Thus, when pressure is provided to the attractant-filled capsule 22 to thereby open up the capsule 22, the attractant is slowly discharged to an outside through the discharge hole 12.

In a use example, a hook 2 and a fishing line 3 are connected to the artificial bait body 10, and the capsule 22 is opened up in response to pressure on the artificial bait body 10 having the capsule 22 therein. If the artificial bait 100 is casted into water using a fishing rod, the water flows into the accommodation space 13 through the inlet hole 11 and thus the attractant is liquefied and then slowly discharged to an outside through the discharge hole 12. If the attractant is discharged to the outside, the attractant spreads in the water and lures nearby fishes. In addition, the user may shake or pull the fishing rod so that a more amount of the attractant is discharged through the discharge hole 12.

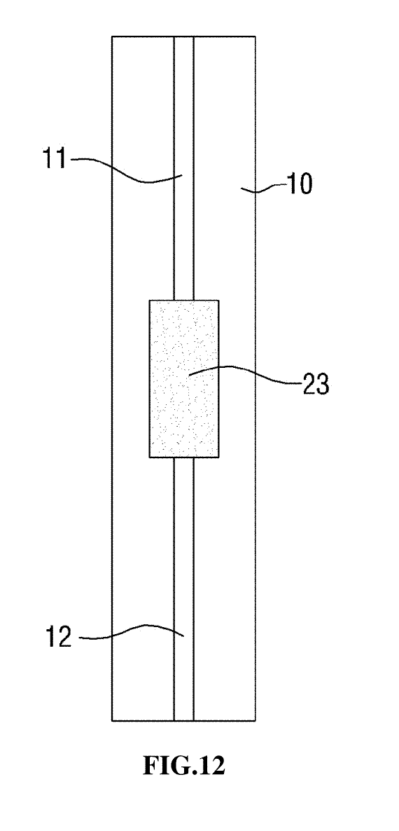

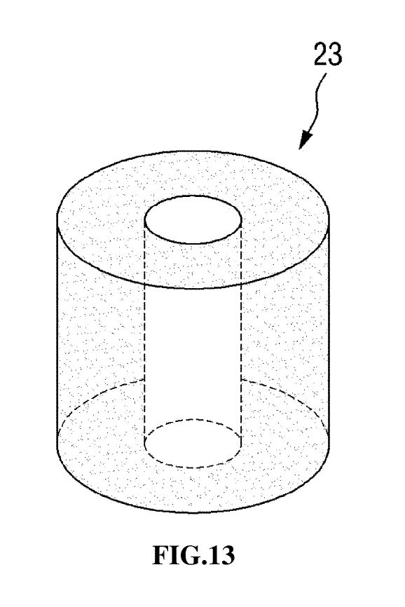

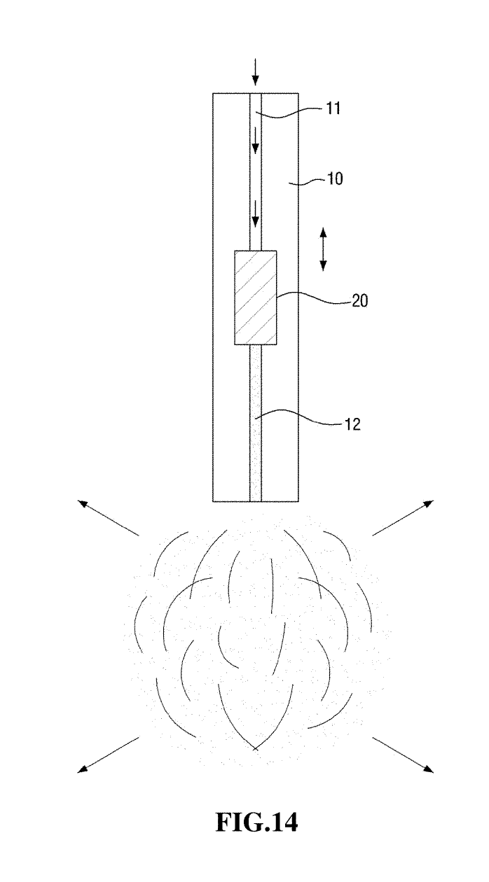

FIG. 12 shows a cross-sectional view of the artificial bait 100 having a foaming-type attracting agent 23 therein according to an embodiment of the present invention. FIG. 13 shows a perspective view of the foaming-type attracting agent 23 according to an embodiment of the present invention. FIG. 14 is a cross-sectional view of the artificial bait 100 in a state in which attractant is discharged by inflow of water according to an embodiment of the present invention.

As described above, the attractant is configured to be in red and composed of at least one from among fish food, fish powder, fish oil, fish blood, grain powder, and organic binder. The foaming-type attracting agent 23 may be made as a solid formulation by further including hydrogen carbonate and carbonate power. That is, the foaming-type attracting agent 23 may be made by further including hydrogen carbonate, sodium hydrogen carbonate, potassium hydrogen carbonate, sodium alendronate hydrate, citric acid, acid alkali, etc.

In a use example, the hook 2 and the fishing line 3 are connected to the artificial bait body 10. If the artificial bait 100 is casted into water using a fishing rod, the water flows into the accommodation space 13 through the inlet hole 11. Then, the foaming-type agent 23 starts to generate foams by reacting with the water. When attractant is discharged to an outside upon the foaming, the attractant spreads in the water and lures nearby fishes. In addition, a user may shake or pull the fishing rod so that a more amount of attractant is discharged through the discharge hole 12.

In addition, the inlet hole 11 and the discharge hole 12 according to an embodiment of the present invention may be in various forms. That is, at least one of the inlet hole 11 or the discharge hole 12 may be formed as at least one or more in a longitudinal direction or an outward direction of the artificial bait body 10 in the accommodation space 13.

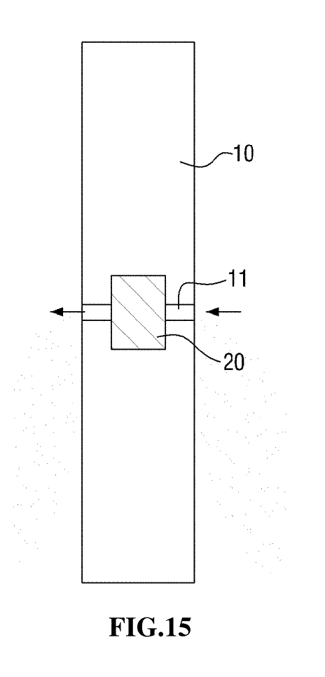

FIG. 15 shows a cross-sectional view of the artificial bait 100 having the inlet hole 11 and the discharge hole 12 formed in a lateral direction according to an embodiment of the present invention. As illustrated in FIG. 15, the inlet hole 11 is formed to penetrate from one side of a side surface of the artificial bait body 10 to the accommodation space 13, and the discharge hole 12 is formed to penetrate from the accommodation space 13 to the other side of the side surface of the artificial bait body 10. Accordingly, water inflowing through the inlet hole 11 may come into contact with the attracting agent 20 formed in various types including the liquid type 21, the capsule type 22, and the foaming type 23 in the accommodation space 13, so that attractant is able to be discharged in the lateral direction through the discharge hole 12.

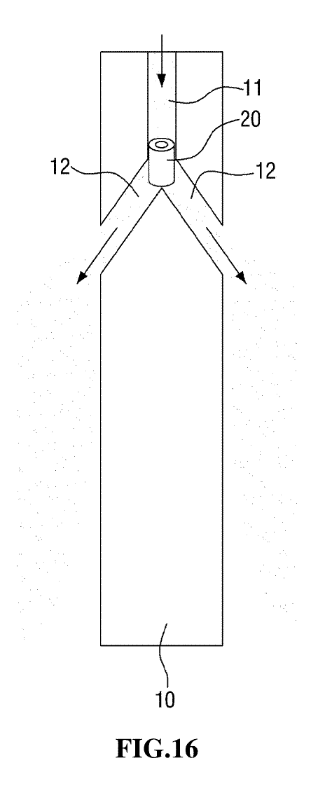

FIG. 16 shows a cross-sectional view of the artificial bait 100 having an inlet hole 11 formed in a longitudinal direction and two discharge holes 12 formed in an inclined manner according to an embodiment of the present invention. As illustrated in FIG. 16, the inlet hole 11 may be formed to penetrate from one side of an upper surface of the artificial bait body 10 to the accommodation space 13, and the plurality of discharge holes 12 may be formed to penetrate from the accommodation space 13 to a side surface of the artificial bait body 10 at a predetermined angle. Accordingly, water inflowing through the inlet hole 11 may come into contact with the attracting agent 20 of various types including the liquid type 21, the capsule type 22, and the foaming type 23 in the accommodation space 13 so that attractant is able to be discharged in a lateral direction through the discharge hole 12.

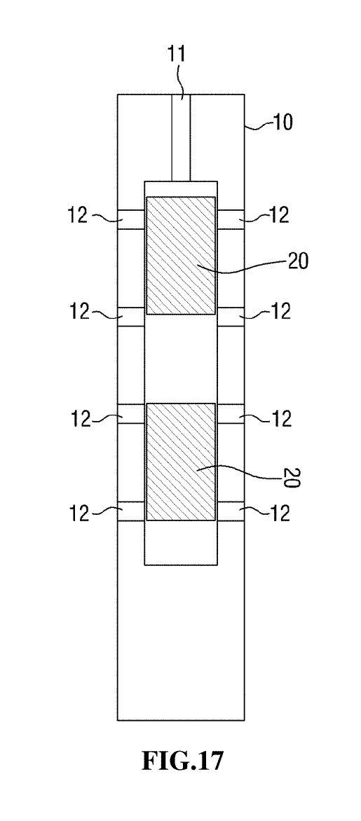

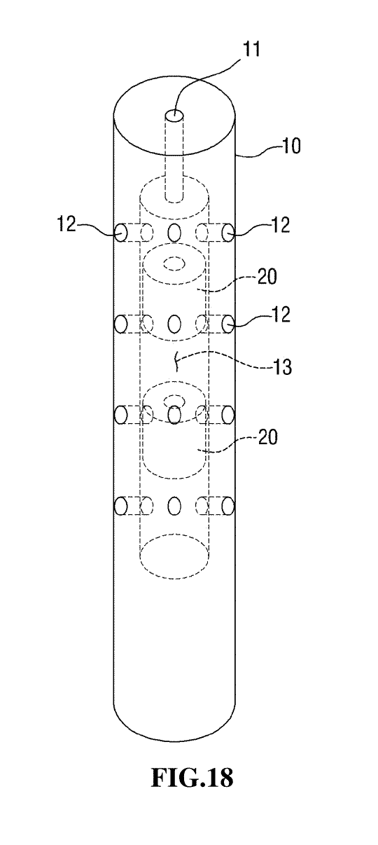

FIG. 17 shows a cross-sectional view of the artificial bait 100 having a plurality of attracting agents 20 provided in the accommodation space 13 and having a plurality of inlet holes 11 and discharge holes 12 formed in a lateral direction according to an embodiment of the present invention. In addition, FIG. 18 shows a perspective view of the artificial bait 100 having a plurality of attracting agents 20 provided in the accommodation space 13 and having a plurality of inlet holes 11 and discharge holes 12 formed in a lateral direction according to an embodiment of the present invention.

As illustrated in FIG. 17, the plurality of attracting agents 20 may be formed in various types including the capsule type 22 and the foaming type 23 in the accommodation space 13, and the inlet hole 11 may be formed to penetrate from one side of an upper surface of the artificial bait body 10 to the accommodation space 13, and the plurality of discharge holes 12 may be formed to penetrate from the accommodation space 13 to the artificial bait body 10. Accordingly, water inflowing through the inlet hole 11 may come into contact with the attracting agents 20 formed in various types including the capsule type 22 and the foaming type 23 in the accommodation space 13 so that an attractant is able to be discharged in a lateral direction through the discharge hole 12.

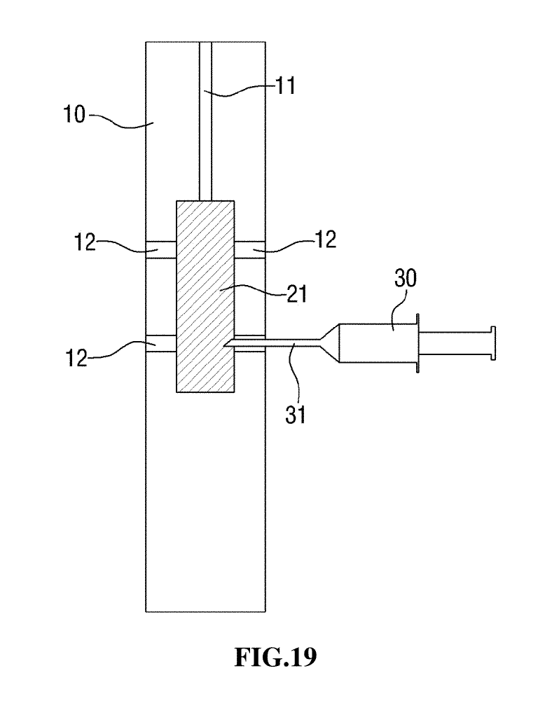

In addition, the attracting agent 20 in the various forms according to an embodiment of the present invention is refillable. FIG. 19 shows a cross-sectional view of a state in which a liquid-type attracting agent 21 is refilled in the accommodation space 13 of the artificial bait body 10 through the liquid injecting device 30 according to an embodiment of the present invention. The liquid-type attracting agent 21 may be refilled by inserting and injecting a needle 31 of a syringe-type liquid injecting device 30 into the artificial bait body 10.

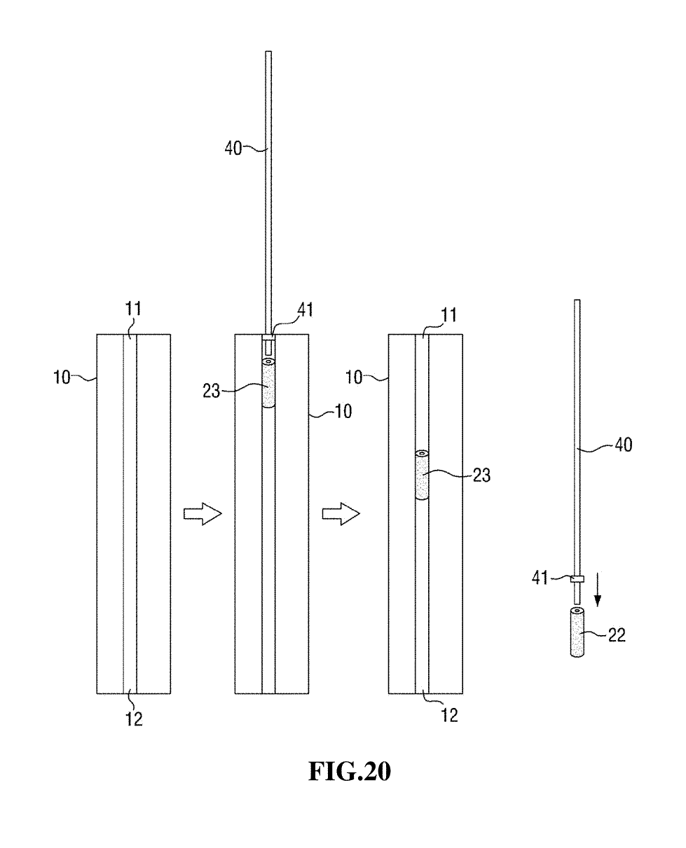

FIG. 20 shows a cross-sectional view of a state in which the attracting agent 20 of the foaming type 23 or the capsule type 22 is refilled through an insertion rod 40 according to an embodiment of the present invention. As illustrated in FIG. 20, the attracting agent 20 of the foaming type 23 or the capsule type 22 may be refilled and reused by mounting the foaming type 23 or the capsule type 22 to the insertion rod 40 having a projection 41 formed therein and then inserting the insertion rod 40 into the inlet hole 11 or the discharge hole 12 to embed the attracting agent 20 in the accommodation space 13.

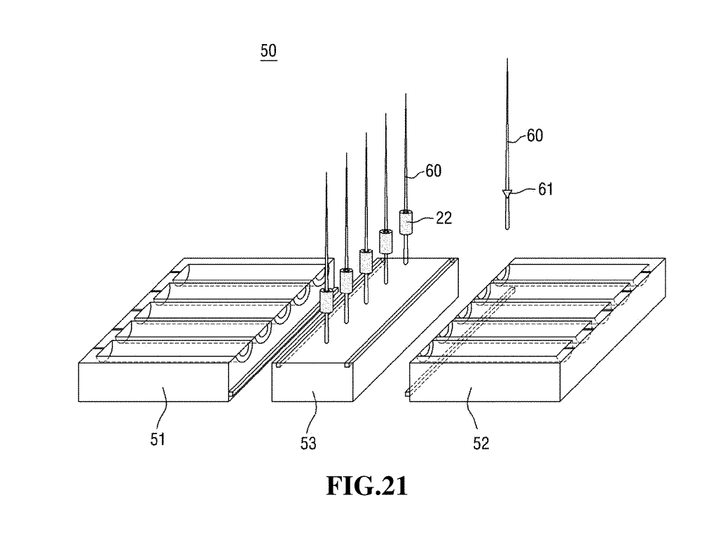

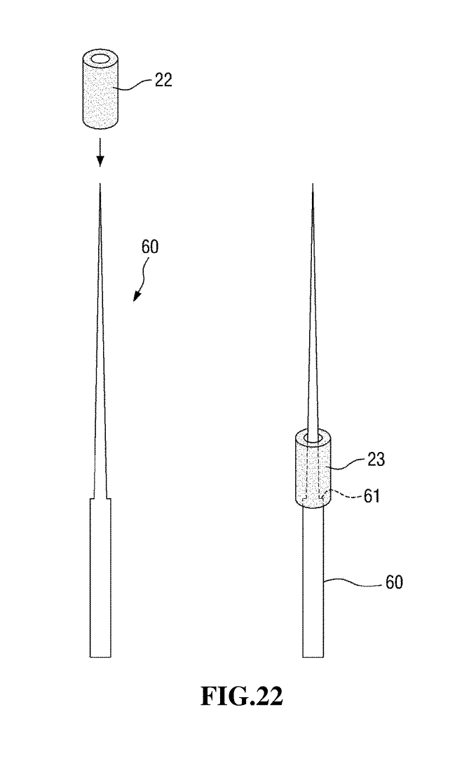

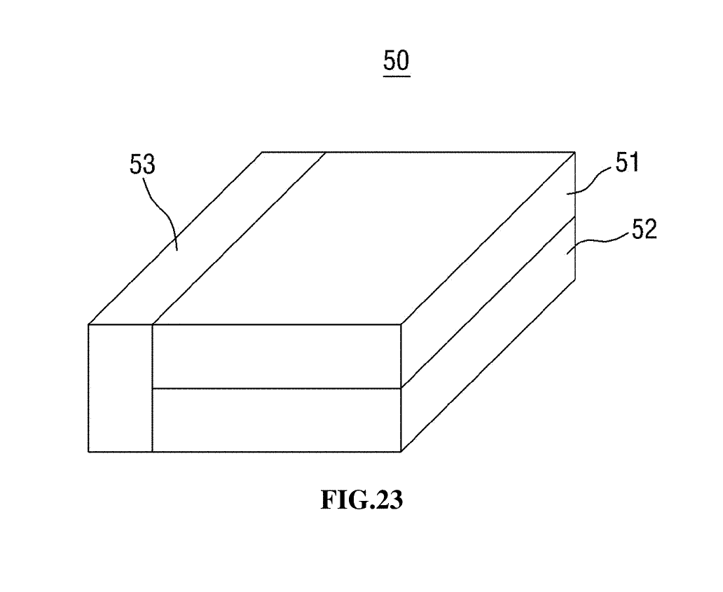

Hereinafter, a method of manufacturing the artificial bait 100 according to an embodiment of the present invention will be described. FIG. 21 shows an exploded perspective view of an apparatus 50 of manufacturing an artificial bait for fishing according to an embodiment of the present invention. FIG. 22 is a front view of an insertion pin 60 installed at a third mold 53 according to an embodiment of the present invention. FIG. 23 is a perspective view of the apparatus 50 of manufacturing an artificial bait for fishing according to an embodiment of the present invention.

As illustrated in FIGS. 21 to 23, in an embodiment of the present invention, it is possible to manufacture a plurality of artificial baits 100 using a mold by an insert-injection molding method. The apparatus 50 may include a first mold 51 corresponding to an upper mold, a second mold 52 corresponding to a lower mold, and the third mold 53 at which the plurality of insertion pins 60 is installed.

The first mold 51 and the second mold 52 are assembled with each other up and down, and the third mold 53 is assembled to a side surface of the assembly of the first mold 51 and the second mold 52 so as to form a mold for insert-injection molding. In addition, the first mold 51 and the second mold 52 may be capable of rotating with reference to the third mold 53.

After being produced, the first mold 51 and the second mold 52 have an inner space that forms the artificial bait body 10, and the insertion pin 60 shown in FIG. 22 is installed at the third mold 53, wherein the insertion pin 60 increases in diameter from one side to the other side or has a projection 61 formed therein so that the attracting agent 20 of the foaming agent 23 or the capsule 22 to be embedded in the accommodation space 13 is inserted into the insertion pin 60 and fixed thereto.

Thus, a plurality of insertion pins 60 each having the attracting agent 20 inserted therein may be installed at the third mold 53, and then the first mold 51 and the second mold 52 may be assembled. Then, an outer skin material for the artificial bait body 10 may be inserted into the inner space between the first mold 51 and the second mold 52, thereby manufacturing the artificial bait 100 according to an embodiment of the present invention.

Thus, using the apparatus 50 for manufacturing an artificial bait, it is possible to quickly manufacture a plurality of artificial baits 100 in a single insert-injection molding process.

In addition, the configuration and method of the aforementioned exemplary embodiments are not limited and applied to the apparatus and method as described above, but some or all of the exemplary embodiments may be selectively combined and configured so that the exemplary embodiments are modified in various ways.

What is claimed is:

1. An artificial bait for fishing, using an attractant, comprising:
an artificial bait body having an accommodation space therein, and an inlet hole through which water flows into the accommodation space by water pressure during fishing; and
an attracting agent made of the attractant and insertably and separably provided in the accommodation space,
wherein the water flowing through the inlet hole comes into contact with the attracting agent to discharge the attractant to an outside through a discharge hole of the artificial bait body during fishing.

2. The artificial bait of claim 1, wherein the attracting agent is in at least one type from among a liquid type, a foaming type, and a capsule type.

3. The artificial bait of claim 1, wherein at least one of the inlet hole or the discharge hole is formed as at least one or more formed in a longitudinal direction or a lateral direction of the artificial bait body in the accommodation space.

4. The artificial bait of claim 2,
wherein the attracting agent is refillable,
wherein the attracting agent of the liquid type is refillable by a liquid injecting device having an injection needle, and
wherein the attracting agent of the foaming type or the capsule type is refillable by mounting the foaming type or the capsule type to an insertion rod and inserting the insertion rod into the inlet hole or the discharge hole.

5. The artificial bait of claim 2,
wherein the attractant is in red and composed of at least one of fish food, fish powder, fish oil, fish blood, grain powder, or organic binder, and
wherein the attracting agent of the forming type further comprises hydrogen carbonate and carbonate powder.
